(19) United States
(12) Patent Application Publication
(10) Pub. No.: US 2007/0265976 A1
(43) Pub. Date: Nov. 15, 2007

(54) License distribution in a packet data network

(76) Inventors: Peter Helfer, Montreal (CA); Jim Dumont, Dollard des Ormeaux (CA); Martin Denis, Vaudreuil (CA)

Correspondence Address: SANDRA BEAUCHESNE;Ericsson Canada Inc., Patent Department, 8400 Decarie Blvd., Town Mount Royal, QC, H4P 2N2, CA

(21) Appl. No.: 11/432,326

(22) Filed: May 12, 2006

(51) Int. Cl. G06Q 99/00

(52) U.S. Cl. 705/59

(57) ABSTRACT

The invention relates to a method, a server and a license manager for distributing licenses for software applications in a packet data network having one or more active servers. The number of licenses distributed from the server decreases when the number of active servers increases and further the number of licenses distributed from the server increases when the number of active servers decreases. The licenses to be issued are installed on the license manager and are further requested by the server. A request for licenses from the server to the license manager is based on a determination from the server of the number of active servers in the packet data network and the number of installed licenses at the license manager.

### TECHNICAL FIELD

The invention relates to the field of license management in distributed computer systems.

### BACKGROUND

License management is used for controlling the use of computer software applications. A software application is designed with a built-in function that allows it to operate only when an appropriate license is available.

A software license typically includes several pieces of encrypted information such as the identity of the licensed application, the time period for which the license is valid, and the number of instances of the application that are permitted to execute simultaneously. A software license may also contain quantitative information such as the maximum number of entities that are allowed to be stored in a database or the maximum number of transactions per second that a server is allowed to deliver.

In order to control the number of computers on which the end-users deploys the licensed software, it is common to include identifying information about the target computer in the encrypted license. In this case an end-user will first have to run an application on the target system(s) to gather the required information such as serial numbers and send the information to the supplier, where it is used to create a tailor-made license that will only work on the intended target computer(s).

In a multi-server system a plurality of servers are connected to a license manager, which can provide a certain number of licenses, distributed across the active servers. If a hardware or software failure occurs at one or more of the active servers, then remedial action is required to automatically restore the service level. This can be accomplished by providing one or more additional standby servers that can be automatically activated in case of a failure. In order to prevent fraudulent end-users from using more than the licensed capacity, the multi-server system is required to make sure that the additional resources can only be activated when there is a loss of capacity.

If an active server fails, then a standby server is activated, and must obtain licenses before it can start to provide service. The license manager, however, must not issue licenses until it has determined that the original server really has stopped providing service. This is accomplished by issuing time-limited licenses and having active servers to periodically request license renewal from the license manager. If a server fails to renew its licenses for software applications within a predetermined period of time for example because a failure occurred at the server, then the license server will consider those licenses available for use by a standby server. For performance reasons, the license expiry time cannot be made arbitrarily short or too much computing and network resources would be used for the license management. Additionally, in order to prevent accidental license expiry and hence service degradation, the servers must be configured to renew their licenses some amount of time before expiry. As a result of these two considerations, there is a period of time after a server fails before the license manager can make the licenses available to another server.

Therefore, there is a need to provide a solution where licenses can be promptly redistributed after a failure of a server and this without introducing opportunities for fraudulent use of licensed systems. The invention provides a solution to this problem.

### SUMMARY

It is a broad aspect of the present invention to provide a method for managing distribution of licenses for software applications in a packet data network, the method comprising the steps of:

receiving, at a server from a license manager, a number of licenses installed at the license manager;

determining, at the server, a number of active servers in the packet data network;

determining, at the server, a number of licenses to be requested to the license manager;

requesting, from the server to the license manager, the determined number of licenses; and

in response to a detection of a modification, at the server, in the number of active servers in the packet data network:

adjusting, at the server, the number of licenses to be requested from the server to the license manager.

It is another broad aspect of the present invention to provide a server for distributing licenses for software applications in a packet data network, the server comprising:

an input/output unit for receiving from a license manager, a number of licenses installed at the license manager; and

a processor for determining a number of active servers in the packet data network determining a number of licenses to be requested to the license manager, requesting to the license manager the determined number of licenses and responsive to a detection of a modification in the number of active servers in the packet data network adjusting the number of licenses to be requested to the license manager.

It is another broad aspect of the present invention to provide a license manager for managing distribution of licenses in a packet data network, the license manager comprising:

a database for storing stores a list of installed licenses associated expiry period of time, a list containing: the identity servers that are allowed to receive licenses, information about currently issued licenses for each server, the number of licenses issued, and an associated expiry time for the licenses;

an input/output unit for receiving from a server for requesting the number of installed licenses at the license manager sending to the server the requested number of installed licenses; and

a processor for retrieving in the database the requested number of installed licenses

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a packet data telecommunications network for providing packet data services an end-user in accordance to the invention.

FIG. 2 is a schematic diagram illustrating the association between a server and a license manager in a packet data network in accordance to the invention;

FIG. 3 a flow chart of a method for updating a database of a license manager in accordance to the invention;

FIG. 4A is a flow chart of a method for managing distribution of licenses for software application in a packet data network in accordance to the invention;

FIG. 4B is a flow chart of a method for determining the number of active server 16 in the packet data network in accordance to the invention; and

FIG. 4C is a flow chart of a method for updating a memory of the server in accordance to the invention.

### DETAILED DESCRIPTION

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

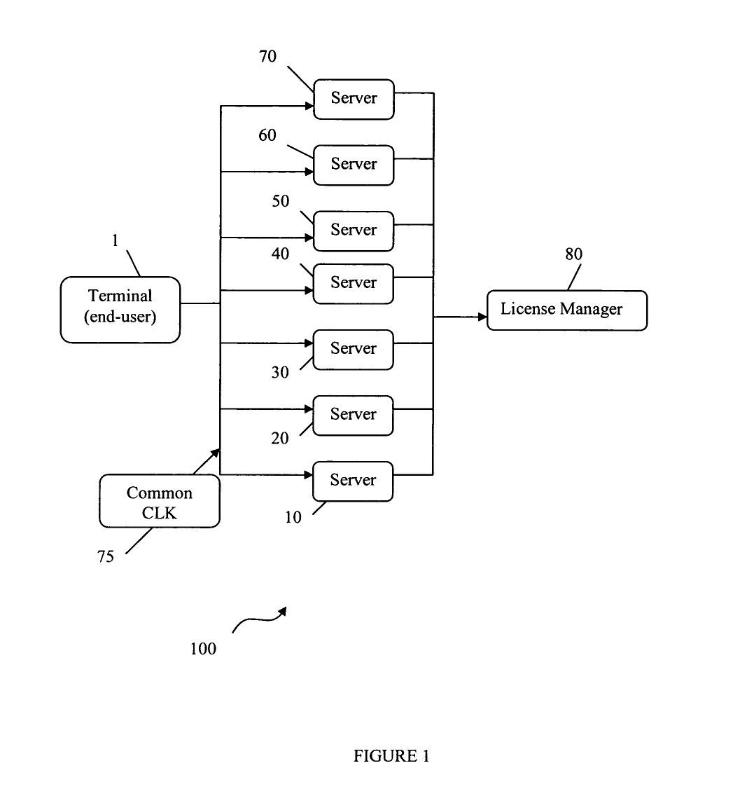

Reference is now made to FIG. 1, which is a schematic diagram illustrating a packet data telecommunications network 100 for providing packet data services to end-user 1 in accordance to the invention. The packet data telecommunication network 100 may be any network that provides packet data services to an end-user on its terminal 1. The packet data telecommunications network 100 can be any server system that handles large numbers of transactions per second, such as messaging systems and high-volume web applications.

The packet data network 100 comprises a plurality of servers 10, 20, 30, 40, 50, 60 and 70 for delivering services to the terminal 1 and a license manager 80 for managing distribution of licenses in the packet data network 100. It can be understood that the network 100 is a simplified network and that the network 100 may comprise more servers than the number of servers 10 to 70 and license manager 80 shown in FIG. 1. The servers 10 to 70 can be any computer-based node adapted to deliver data such as e-mails, file transfers, and other network services and software applications to other computers linked by the network 100. The license manager 80 can be any computer-based node adapted to manage a distribution of software licenses across active servers in the packet data network 100.

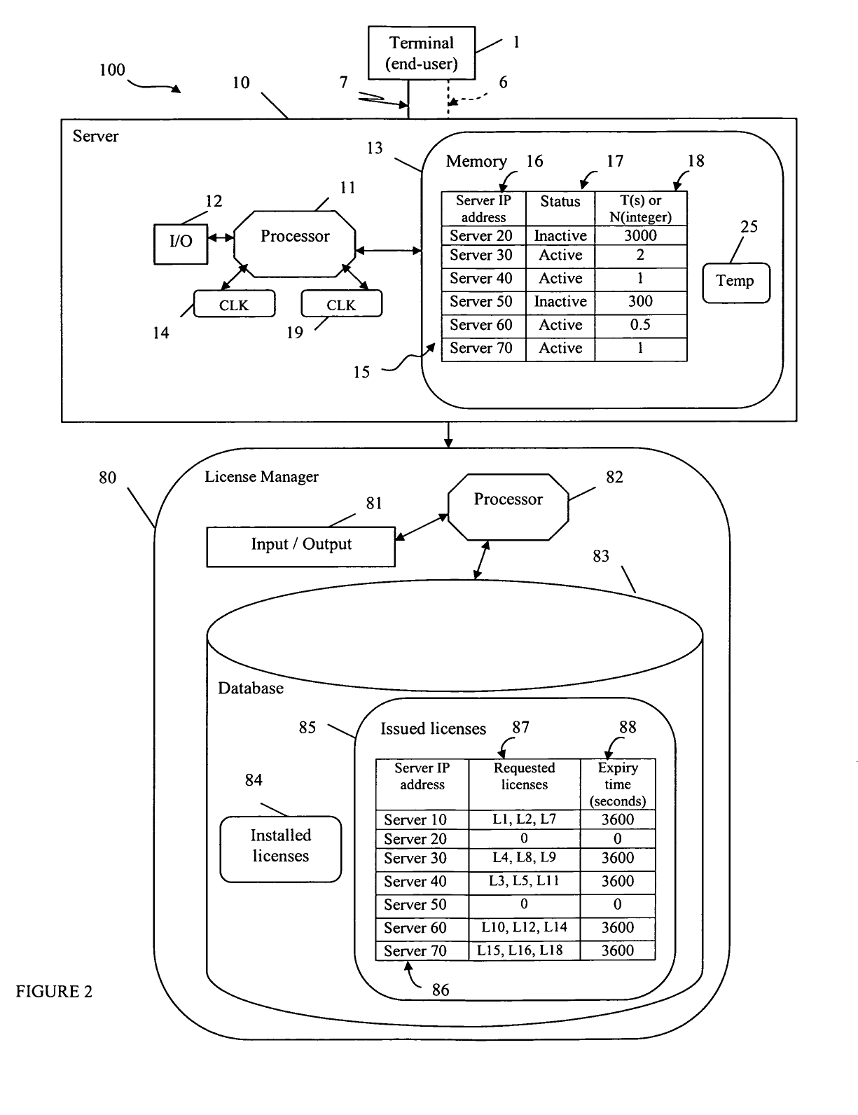

Reference is now made to FIG. 2, which is a schematic diagram illustrating the association between the server 10 and the license manager 80 in the packet data network 100 in accordance to the invention. In FIG. 2, the end-user uses its terminal 1 and requests a packet data service from the server 10. The terminal 1 can be any computer-based equipment fixed or mobile equipment that is adapted to receive software application via a wireless connection 6 and a wired connection 7 such as messaging clients for Multimedia Messaging System (MMS), Short Message Service (SMS), e-mail or other Internet clients such as web browsers, or game clients that require licenses.

The server 10 verifies that it is in possession of a license to provide the requested service, and that the license permits the service to be provided at the present time, given the number of requests served the current time interval. The server 10 comprises an input/output (I/O) unit 12 for receiving information from the network 100 and for sending information to the network 100, a processor 11 for operating the license manager 80, a memory 13 for storing information that can be accessed by the processor 11. The server 10 also comprises a timer CLK 14 for determining a first period of time before looking into the memory 13 in order to detect if the number of active servers is modified in the packet data network 100 and a timer CLK 19 for determining a second period of time before requesting a renewal of licenses from the server 10 to the license manager 80. The memory 13 stores a list 15 for listing the identity or IP address of servers 16 in the packet data network 100, a status 17 for these servers 16, which can be “active” or “inactive”, and time differential 18, which indicates the difference of time between a last reception of an indication at a first server from a second server and the preceding reception of an indication at the first server from the second server.

The servers 10 to 70 are connected to a license manager 80. The communication between the servers 10 to 70 and the license manager 80 may be based on Transmission Control Protocol/Internet Protocol (TCP/IP) or some other protocol. The license manager 80 comprises an input/output (I/O) unit 81 for receiving information from the network 100 and for sending information to the network 100, a processor 82 for operating the license manager 80, a database 83 for storing information that can be accessed by the processor 82. The database 83 and the memory 13 may be any persistent memory such as a file system, a Read-Only Memory (ROM) or a Structured Query Language (SQL) database. The processors 11 and 81 can be hardware, software, or any combination thereof. The database 83 stores a list of installed licenses 84. The installed licenses 84 contain the number of licenses with having an associated expiry period of time for such licenses that may simultaneously be issued to servers 10 to 70. This information is provided to the operator of the packet data network from the software vendor of the software application from which the license relates. This information is provided in an encrypted form to the operator. The database 83 also stores a list 85 that contains: the identity or IP address 86 of the servers 10 to 70 that are allowed to receive licenses, information about currently issued licenses for each server 86, the number of issued licenses 87, and the expiry time period 88 for the issued licenses 87. The number of issued license 87 is the number of requested installed licenses 84 from the servers 10 to 70. For instance, the server 30 has requested three licenses to the license manager 80 and thus the license manager 80 updates the list 85 with the identity of the licenses (L4, L8 and L9) in the issued licenses 87 for the server 30.

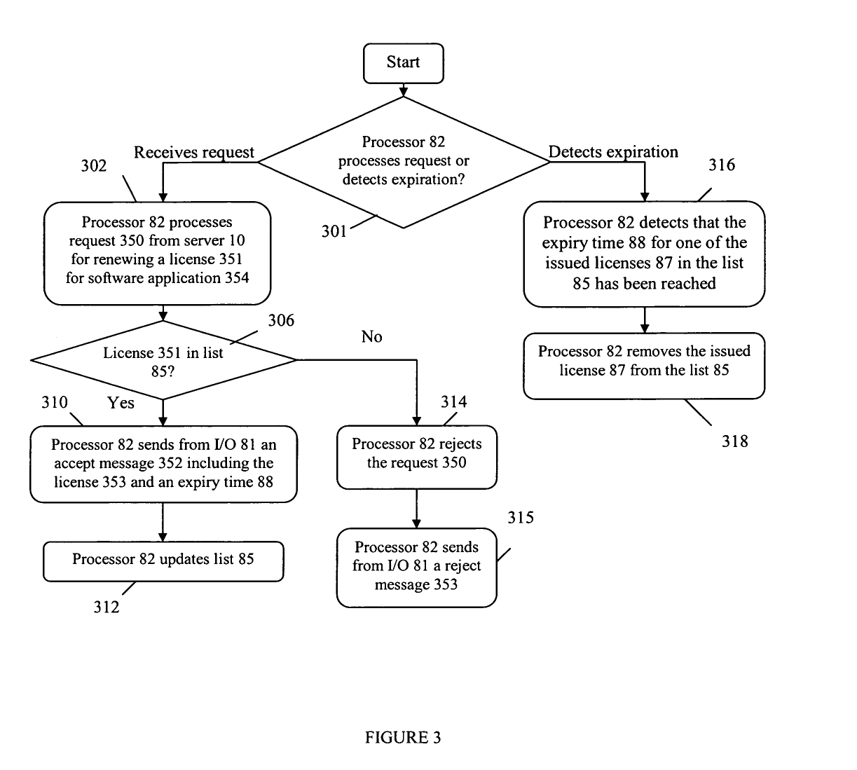

Reference is now made to FIG. 3, which is a flow chart of a method for updating the database 83 in accordance to the invention. The content of the database 83 is updated based on an event such as the reception at the license manager 80 of a request sent from one of the servers for renewing one or more licenses for software applications or a detection at the license manager 80 that one or more licenses 87 the expiry time has been reached. For example, at step 301, the license manager 80 receives from the server 10 a request 350 for renewing a license 351 for a software application 354. The request 350 includes an identification of the license 351. Next, the processor 82 processes the request message 350 (step 302) and verifies that the license 351 is in the list 85 (step 306). If at step 306, the license 351 is in the list 85, the processor 82 sends from the I/O 81 an accept message 352 including a license 353 for the software application 354 associated with the license 351 and an expiry time 88 associated to the license 353 (step 310). The list 85 is then updated with the information sent to the server 10 (step 312). Otherwise, if the license is not in the list 85, the processor 82 rejects the request 350 (step 314) and the processor 82 sends from I/O 81 a reject message 353 to the server 10 (step 315).

Alternatively, at step 301, the processor 82 can detect that an expiry time is reached for one or more of the issued licenses 87 in the list 85 (step 316) for the reason that a server such as server 10 has failed to renew one or more license 87 for a software since of a failure occurred at the server 10 or for any other possible reasons. If this is the case, the processor 82 removes the issued license 87 from the list 85 and license manager 80 render the license available for use by another server (step 318).

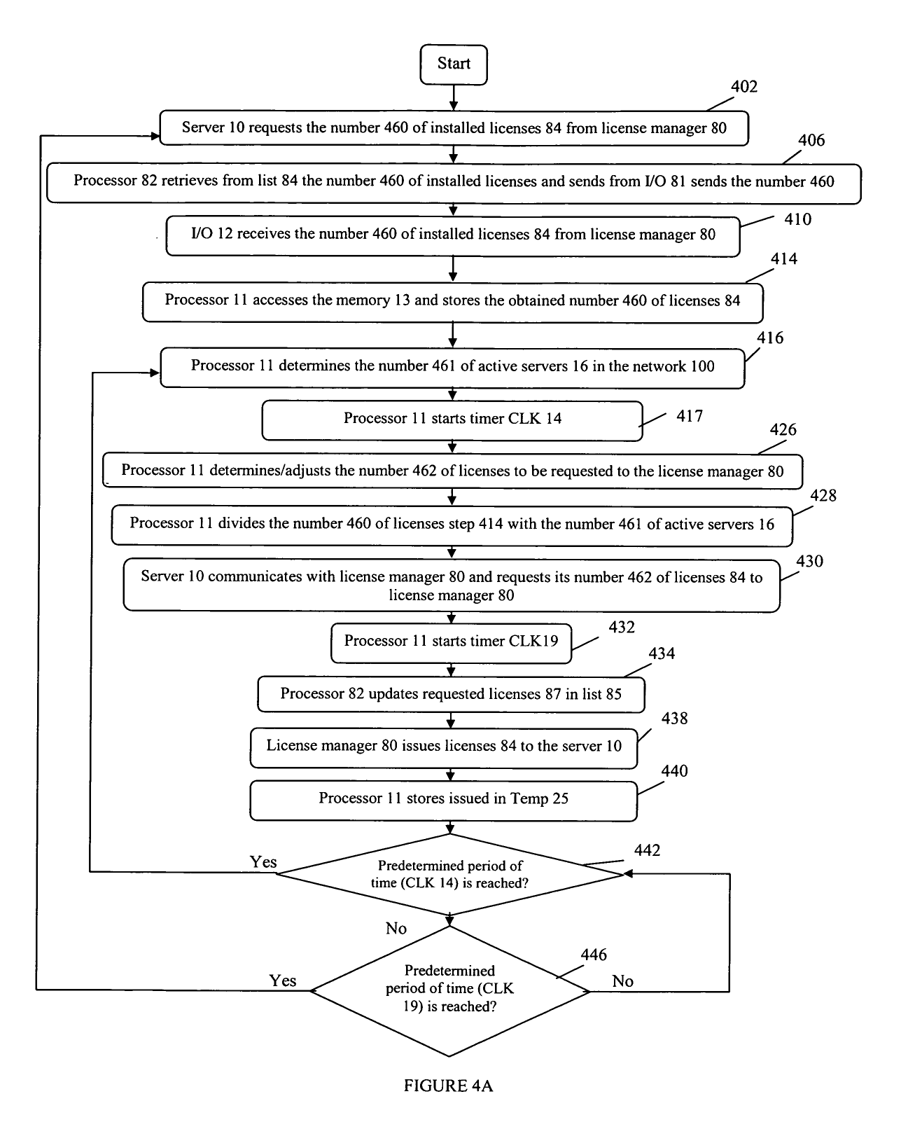

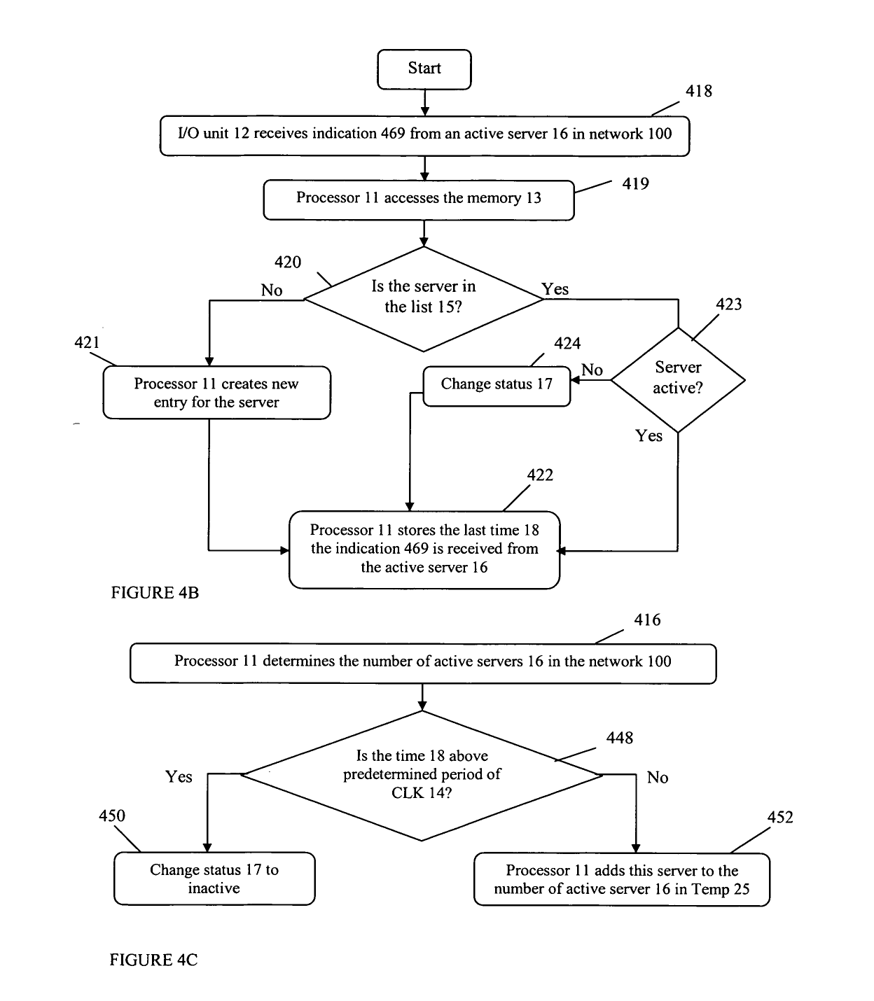

Reference is now made to FIG. 4A, which is a flow chart of a method for managing distribution of licenses for software application in the packet data telecommunications network 100 in accordance to the invention. At step 402, the server 10 requests from the license manager 80 the number 460 of installed licenses 84 for simultaneous use by the servers 10-70. The license manager 80 receives the request at the I/O 81 and the processor 82 retrieves the number 460 of installed licenses 84 (step 406). The license manager 80 then sends via the I/O 81 the number 460 of installed licenses 84 to the server 10 (step 410). At step 410, the I/O 12 receives the number 460 of installed licenses 84. After that, the processor 11 accesses the memory 13 and stores the obtained number 460 of installed licenses 84 in the temporary memory (Temp) 25, at step 414.

During the execution of steps 402 to 414 or following step 414, the server 10 determines the number 461 of active servers 16 among servers 20 to 70 by looking in a list 15 and by communicating with these servers (step 416). Following this, the processor 11 starts the timer CLK 14 (step 417). When the timer CLK 14 reaches a predetermined period of time, the server periodically retrieves from the list 15 the number 461 of active servers 16.

As shown in FIG. 1, the timer for CLK 14 can be synchronized with a timer CLK 75. The timer CLK 75 is common to the servers 20 to 70 and may be synchronized with timers CLK (not shown), which are similar to CLK 14, in servers 20 to 70 for starting simultaneously these timers with CLK 14. The predetermined period of time can be any threshold configured by an operator or configured in the timer CLK 14.

Reference is now made to FIG. 4B, which is a flow chart of a method for determining the number 461 of active server 16 in the packet data network 100 in accordance to the invention. The determination of the number 461 active servers 16 can be accomplished by having all active servers 16 to periodically broadcast heartbeat messages to each other over the network 100, by storing time-stamped files in a shared file system, or by other means (step 418). For instance, if the server 10 receives at the I/O 12 an indication 469 from the server 20, the processor 11 accesses the memory 13 (step 419) verifies that the server 20 is in the list 15 of active servers 16 (step 420). If the server 20 is in the list 15 of active servers 16, the processor 11 stores the time differential 18 for the indication 469 (step 422). The server 20 may be present in the list 15, but its status may be “inactive”. For that reason, when the indication 469 is received at the server 10, the processor verifies the status 17 of the server, at step 423. If the status 17 for the server is inactive, then the processor 11 changes the status 17 of the sending server (step 424). The time differential 18 indicates the difference between the last reception of an indication at server 10 from a second server and the preceding reception of an indication at server 10 from the second server.

Alternatively, if the server 20 is missing from the list 15 of active servers 16, the processor 11 creates a new entry for server 20 (step 421) and stores the time 18 that the indication 469 is received from the server 20 at the I/O 12 (step 422). The server 10 also provides a similar indication to other servers 20 to 70. The broadcast of indications among the servers 10 to 70 can be simultaneous or based on a timer such as the common timer CLK 75.

Reference is now made to FIG. 4C, which is a flow chart of a method for updating the memory 13 of the server 10 in accordance to the invention. If the server 10 does not receive an indication from a server during the predetermined period of time before CLK 14 is reached, the server is considered inactive. More particularly, at step 416, the processor 11 determines the number 461 of active servers 16 after CLK 14 has been reached. If at step 448, the time differential 18 for the last indication received from a server is above the predetermined period of time for CLK 14, the server is considered “inactive” and if the previous status 17 for that server is “active”, then the list 15 is updated and the server is listed as “inactive” (step 450). If at step 448, the time differential 18 is below the predetermined period of time for CLK 14, the processor 11 add up this server to the number 461 of active server 16 in Temp 25 (step 452).

At step 426, the processor 11 determines and adjusts the number 462 of licenses 88 to be requested to the license manager 80. The determination is done by dividing the number 460 of licenses 84 stored in Temp 25 by the number 461 of active servers 16 (step 428) stored in Temp 25 or taken directly from the list 15. If the number 460 of licenses 84 cannot be divided evenly, then a simple algorithm is used to determine which servers get an extra license. For example, each server may be identified by an integer ID, and if the remainder after division is R, then those servers with an ID less than or equal to R get an extra license.

The number 460 of installed licenses 84 is also the current number of installed licenses at the licenses manager 84 when requested from server 10. It can be understood that this number 460 of licenses 84 may vary between a request performed at step 402 and another request performed when step 402 is repeated. For instance, the number 460 of installed licenses 84 can vary when one or more additional licenses are purchased by the end-user 1 or a plurality of end-users and installed on the license manager 80. Furthermore, the number 460 of installed licenses is the number of licenses installed when requested from the server 10 to the license manager 80 at step 402. Furthermore, the number 461 of active servers 16 is the current number of active server 16 or the total number of active server 16 when the server 10 performs or repeats step 416 for periodically determining the number 461 of active servers in the packet data network 100.

At step 430, the server 10 communicates with the license manager 80 and requests the number 462 of licenses 84 to the license manager 80 and adjusts its service level, which is the number 462 of requested licenses 84 to be ultimately processed at the server 10. At step 432, the processor 11 starts the timer CLK 19. Subsequently, the processor 82 updates the issued licenses 87 with the licenses 84 which have been issued based on the number 462 of installed licenses requested from the server 10 (step 434). At step 438, the license manager 80 issues the requested licenses 84 with associated expiry time period 88 to the server 10. A license issued by the license manager 80 to a server 10 is rendered available to other servers 20 to 70, if the expiry time 88 for the license is reached. The license manager 80 control the expiry time 88 by counting down the time of expiry of the license when it is issued to a server. The counting down can be done for example by means of a timer (not shown). Next, the I/O unit 12 receives the requested licenses 84 with associated expiry time 88. The processor 11 stores the requested licenses 84 and the expiry time 88 in the Temp 25 (step 440).

If at step 442, a predetermined period of time CLK 19 is reached for updating the number of licenses to be used by the server 10 based on the number of active servers, the server 10 determines the number of active servers (step 416) by looking in the list 15 and thus listening to broadcasted indication from other servers (step 418) and adjusts the number of licenses to be requested to the license manager 80 (step 426). The predetermined period of time can be any threshold configured by an operator or configured in the timer CLK 19. Thus, server 10 continuously verifies the number of participating servers and adjusts the number of licenses to be requested. At step 426, the number of licenses to be requested by the processor 11 increases if the number of active servers 16 decreases due to a failure at one or more servers in the packet data network 100 and the number of licenses to be requested decreases if the number of active servers 16 increases due to the reactivation of one or more servers in the packet data network 100.

More particularly, if a failure occurs at one or more servers 10 to 70 in the packet data network 100, the remaining servers automatically increase their capacity. If a failed server comes from an inactive status 17 to an active status 17, then the servers of the network 100 reduce their capacity to let the restored server request its number of licenses to the license manager 80. Periodically all the servers re-retrieve the number of installed licenses 84 from the license manager 80 and re-request their number of licenses. For instance, the server 10 can quickly respond to a failure at one of the servers and restore the service level of the packet data network 100 by frequently adjusting its service level to the number of active servers.

The server 10 can then adjusts its service level in order to respond to a modification in the number of installed licenses 84 for example when additional licenses have been purchased the end-user or a plurality of end-users and installed on the license manager 80 when the number 461 of active servers 16 is modified in the packet data network 100.

Alternatively, if at step 442 the predetermined period of time CLK 14 is not reached, the processor 11 continues to issue licenses until another predetermined period of time for CLK 19 for requesting license renewal from the license manager 80 is reached (step 446). When the processor 11 determines, at step 452, that the server 10 needs new licenses for a software application it goes back to step 402 and requests from the license manager 80 the number of installed licenses for simultaneous use by the servers 10 to 70. Thus, the server 10 and the license manager 80 are able to periodically repeat steps 402 to 446 in order to renew its licenses at the license manager 80 and to adjust the service level of the server 10 based on the number of active servers.

It can be understood that the packet data network 100 is a multi-server system and that other servers 20 to 70 also comprise similar software and hardware elements such as the processor 11, the I/O unit 12, the memory 13, the list 15 and the CLK 14 and 19. Consequently, if a failure occurs at the server 10, other servers are equipped to perform the steps of the method described in FIGS. 4A to 4C.

Alternatively, the time differential 18 can also be a number of (N) cycles. A cycle can be defined when the CLK 14 starts and is reached. The predetermined period of time for CLK 14 can then be a predetermined threshold for CLK 14 consisting of a number of maximum cycles before determining the number of active server. In the same way, the period of time for renewing licenses for software applications can also be a number of (N) cycles. A cycle can be defined when the CLK 19 starts and is reached. The predetermined period of time for CLK 19 can then be a predetermined threshold for CLK 19 consisting of a number of maximum cycles before determining when to renew licenses for software applications.

It can also be understood that some messages and therefore some parameters sent between network elements of the packet data network 100 are omitted for clarity reasons. More particularly, it should also be understood that FIGS. 1 to 4C depict a simplified packet data network 100, and that many other network elements have been omitted for clarity reasons only. Hence, the packet data network 100 may comprise more than one license manager 80. In the same way, the packet data network 100 can be accessed by more than one terminal and that a plurality of terminals can accessed simultaneously the packet data network 100

While the invention has been particularly shown and described with reference to the preferred embodiments thereof, it will be understood by those skilled in the art that various alterations may be made therein without departing from the spirit and scope of the invention.

What is claimed is:

1. A method for managing distribution of licenses for software applications in a packet data network, the method comprising the steps of:
receiving, at a server from a license manager, a number of licenses installed at the license manager;
determining, at the server, a number of active servers in the packet data network;
determining, at the server, a number of licenses to be requested to the license manager;
requesting, from the server to the license manager, the determined number of licenses; and
in response to a detection of a modification, at the server, in the number of active servers in the packet data network:
adjusting, at the server, the number of licenses to be requested from the server to the license manager.

2. The method of claim 1, wherein the method executes the following steps prior the step of receiving:
sending, from the server to the license manager, a request for requesting the number of installed licenses at the license manager;
retrieving, at the license manager, the requested number of installed licenses; and
sending, from the license manager to the server, the requested number of installed licenses.

3. The method of claim 1, wherein the step of determining the number of active servers in the packet data network further includes the steps of:
receiving, at the server, an indication from an active server in the packet data network;
accessing, at the server, a memory, wherein the memory stores a list of active servers and inactive servers, a status for inactive servers and active servers and a time differential between a reception of a last indication from the active server and a reception of a preceding indication from the active server; and
determining, at the server, whether the active server sending the indication is present in the list:
if the active server is present in the list of active servers in the packet data network:
the server:
updates the status for the active server in the memory;
stores the time differential for the indication;
if the active server is missing from the list of active servers in the packet data network:
the server:
creates, in the list, a new entry for the active server sending the indication; and
stores the time differential for the indication.

4. The method of claim 1, wherein the step of determining the number of active servers in the packet data network includes the steps of:
repeating, at the server, the steps of:
starting, at the server, a first timer;
determining, at the server, that a first predetermined period of time has been reached for the first timer; and
determining, at the server, the number of active servers in the packet data network.

5. The method of claim 1, wherein the step of determining the number of active servers in the packet data network further includes the steps of:
determining, at the server, whether the time differential for an indication of the active server is above a first predetermined period of time;
if the time differential is above the first predetermined period:
the server changes the status of the active server to inactive; and
if the time differential is below the first predetermined period:
the server adds up the active server to the number of active server.

6. The method of claim 1, wherein the step of determining the number of licenses to be requested to the license manager further includes a step of dividing, at the server, the received number of installed licenses and the number of active servers in the packet data network.

7. The method of claim 1, wherein the step of requesting includes the steps of:
updating, at the license manager, the requested installed licenses in a list stored in a database; and
issuing, from the license manager to the server, the requested installed licenses.

8. The method of claim 1, wherein the step of requesting includes the steps of:
repeating, at the server, the steps of:
starting, at the server, a second timer;
determining, at the server, that a second predetermined period of time has been reached for the second timer; and
sending, from the server to the license manager, a request message for renewing a license.

9. The method of claim 8, wherein the step of sending includes the steps of:
determining, at the license manager, whether the license is in the list stored at the database:
if the license is in the list of issued licenses:
the license manager:
sends to the server an accept message, the accept message including the license and an expiry time period;
updates the list in the database; and
if the active server is missing from the list of issued licenses:
the license manager:
rejects the request message; and
sends a reject message to the server.

10. The method of claim 9, wherein the method further comprises the steps of:
detecting, at the license manager, that an expiry time period has been reached for an issued license; and
removing, from the list, the issued license.

11. The method of claim 1, wherein the step of adjusting further comprises the step of:
increasing, at the server, the number of licenses to be requested from the server to the license manager when the server determines that number of active servers decreases; and
decreasing, at the server, the number of licenses to be requested from the server to the license manager when the server determines that number of active servers increases.

12. The method of claim 1, wherein the number of active servers in the packet data network is the current number of active server in the packet data network.

13. The method of claim 1, wherein the number of installed licenses at the license manager is the current number of licenses installed at the license manager.

14. A server for distributing licenses for software applications in a packet data network, the server comprising:
an input/output unit for receiving from a license manager, a number of licenses installed at the license manager; and
a processor for determining a number of active servers in the packet data network determining a number of licenses to be requested to the license manager, requesting to the license manager the determined number of licenses and responsive to a detection of a modification in the number of active servers in the packet data network adjusting the number of licenses to be requested to the license manager.

15. The server of claim 14, wherein the server further comprises:
a memory for storing a list of active servers and inactive servers, a status for inactive servers and active servers and a time differential between a reception of a last indication from an active server and a reception of a preceding indication from the active server; and
wherein the processor accesses the memory following a reception at the input/output unit of an indication from an active server in the packet data network and determines whether the active server sending the indication is present in the list:
if the active server is present in the list of active servers in the packet data network:
the processor:
updates the status for the active server in the memory;
stores at the memory the time differential for the last indication;
if the active server is present in the list of active servers in the packet data network:
the processor:
updates the status for the active server in the memory;
stores the time differential for the indication;
if the active server is missing from the list of active servers in the packet data network:
the processor:
creates, in the list, a new entry for the active server sending the indication; and
stores the time differential for the indication.

16. The server of claim 15, wherein the processor further determines whether the time differential for an indication of the active server is above a first predetermined period of time:
if the time differential is above the first predetermined period:
the processor changes the status of the active server to inactive; and
if the time differential is below the first predetermined period:
the processor adds up the active server to the number of active server.

17. The server of claim 14, wherein processor divides the received number of installed licenses and the number of active servers in the packet data network before determining the number of licenses to be requested to the license manager further includes a step of dividing.

18. The server of claim 14, wherein the processor repeats, the steps of:
starting a first timer;
determining that a first predetermined period of time has been reached for the first timer; and
determining the number of active servers in the packet data network.

19. The server of claim 14, wherein the processor repeats the steps of:
starting a second timer;
determining, at the server, that a second predetermined period of time has been reached for the second timer; and
sending, from the server to the license manager, a request message for renewing a license.

20. The server of claim 14, wherein the processor increases the number of licenses to be requested to the license manager when the processor determines that number of active servers decreases and decreases the number of licenses to be requested to the license manager when the processor determines that number of active servers increases.

21. A license manager for managing distribution of licenses in a packet data network, the license manager comprising:
a database for storing stores a list of installed licenses associated expiry period of time, a list containing: the identity servers that are allowed to receive licenses, information about currently issued licenses for each server, the number of licenses issued, and an associated expiry time for the licenses;
an input/output unit for receiving from a server for requesting the number of installed licenses at the license manager sending to the server the requested number of installed licenses; and
a processor for retrieving in the database the requested number of installed licenses.

22. The license manager of claim 21, wherein the processor further updates in the list the licenses requested from the server and issues the requested licenses to the server.

23. The license manager of claim 21, wherein the processor further determines whether the license is in the list stored at the database:
if the license is in the list of issued licenses:
the input/output unit sends to the server an accept message, the accept message including the license and an expiry time period;
the processor updates the list in the database; and
if the active server is missing from the list of issued licenses:
the processor rejects the request message; and
the input/output unit sends a reject message to the server.
